(19) United States
(12) Patent Application Publication
(10) Pub. No.: US 2013/0334921 A1
(43) Pub. Date: Dec. 19, 2013

(54) MOTOR STRUCTURE

(71) Applicant: Metal Industries Research & Development Centre, Kaohsiung City (TW)

(72) Inventors: Guang-Miao Huang, Kaohsiung City (TW); Hsing-Chih Tsai, Kaohsiung City (TW); Kuo-Yin Tu, Kaohsiung City (TW); Ming-Hung Chien, Kaohsiung City (TW)

(73) Assignee: METAL INDUSTRIES RESEARCH & DEVELOPMENT CENTRE, Kaohsiung City (TW)

(21) Appl. No.: 13/896,431

(22) Filed: May 17, 2013

(30) Foreign Application Priority Data
Jun. 19, 2012 (TW) 101121859

(51) Int. Cl. H02K 1/17

(52) U.S. Cl. CPC H02K 1/17
USPC 310/154.08

(57) ABSTRACT

A motor structure includes a case, a rotor, a first magnet, a second magnet and at least one magnetic conductive plate, wherein the rotor is disposed within an accommodating slot of the case, and the first magnet is disposed between the case and the rotor. The first magnet comprises a first end portion spaced apart with the case to define a first separation space. The second magnet comprises a second end portion spaced apart with the case to define a second separation space. A spacing slot is composed of the first separation space and the second separation space, and the at least one magnetic conductive plate is disposed within the spacing slot. The magnetic conduction through the at least one magnetic conductive plate enables to lower the reluctance of the motor structure for prevention of magnetic flux leakage therefore increasing the air-gap flux density.

### FIELD OF THE INVENTION

The present invention is generally related to a motor structure, which particularly relates to the motor structure with a magnetic conductive plate.

### BACKGROUND OF THE INVENTION

Referring to FIG. 1, a conventional motor structure 10 includes a case 11, a first magnet 12, a second magnet 13 and a rotor 14, wherein the case 11 comprises an accommodating slot 11a, and the first magnet 12, the second magnet 13 and the rotor 14 are disposed within the accommodating slot 11a.

The rotor 14 is rotatable through the magnetic conduction of the case 11. However, on account of cost consideration, the manufacturers usually fabricate the case 11 and make the thickness of the case 11 thinner, so that the magnetic flux leakage is occurred. Accordingly, the air-gap flux density is affected to be lower therefore degrading rotation performance.

### SUMMARY

The primary object of the present invention is to provide a motor structure for lowering the reluctance of the motor structure through a magnetic conductive plate disposed between a case and a magnet to prevent magnetic flux leakage from happening so that the air-gap flux density of the motor structure is increased therefore raising rotation performance.

A motor structure in accordance with the present invention includes a case, a rotor, a first magnet, a second magnet and at least one magnetic conductive plate. The case comprises an accommodating slot, the rotor is disposed within the accommodating slot, the first magnet is disposed between the case and the rotor, and the second magnet is disposed between the case and the rotor. The first magnet comprises a first end portion, wherein the first end portion and the case are spaced apart to define a first separation space. The second magnet comprises a second end portion, wherein the second end portion and the case are spaced apart to define a second separation space, and a spacing slot is composed of the first separation space and the second separation space. The at least one magnetic conductive plate is disposed within the spacing slot and contacts the case. The reluctance of the motor structure is well reduced through the at least one magnetic conductive plate to prevent the magnetic flux leakage from happening so as to increase the air-gap flux density therefore raising rotation performance.

### DESCRIPTION OF THE DRAWINGS

FIG. 1 is a section view illustrating a conventional motor structure.

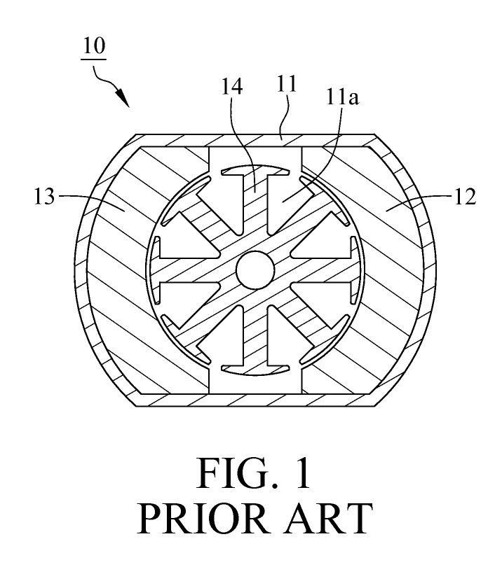

FIG. 2 is a section view illustrating a motor structure in accordance with an embodiment of the present invention.

FIG. 3 is a section view illustrating the motor structure in accordance with the embodiment of the present invention.

FIG. 4 is a perspective view illustrating a magnetic conductive plate in accordance with the embodiment of the present invention.

### DETAILED DESCRIPTION OF THE INVENTION

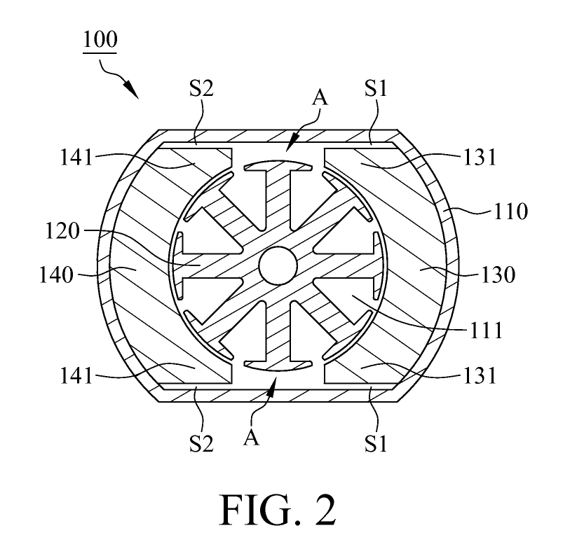

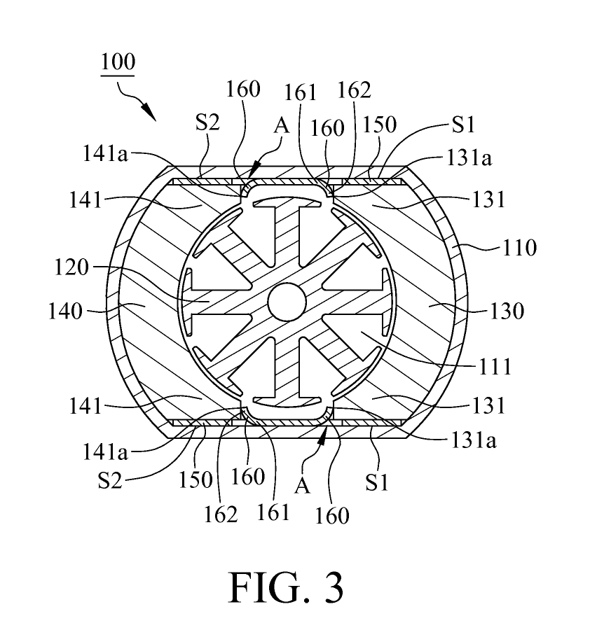

With reference to FIGS. 2 and 3, a motor structure 100 in accordance with an embodiment of the present invention includes a case 110, a rotor 120, a first magnet 130, a second magnet 140 and at least one magnetic conductive plate 150. The case 110 comprises an accommodating slot 111, and the rotor 120 is disposed within the accommodating slot 111.

With reference to FIG. 2, the first magnet 130 and the second magnet 140 are both disposed between the case 110 and the rotor 120, in this embodiment, the first magnet 130 and the second magnet 140 are disposed at two sides of the rotor 120 respectively, and the first magnet 130 is not in contact with the second magnet 140. The first magnet 130 comprises a first end portion 131, the second magnet 140 comprises a second end portion 141, wherein the first end portion 131 and the case 110 are spaced apart to define a first separation space S1, the second end portion 141 and the case 110 are spaced apart to define a second separation space S2, and a spacing slot A is composed of the first separation space S1 and the second separation space S2.

Referring to FIG. 3, the at least one magnetic conductive plate 150 is disposed within the spacing slot A and contacts the case 110, through the magnetic conduction of the at least one magnetic conduction plate 150, the reluctance of the motor structure 100 is well reduced to prevent the magnetic flux leakage from happening so that the air-gap flux density is increased therefore raising rotation performance.

Referring to FIG. 3, the motor structure 100 further includes at least one positioning member 160 disposed between the first end portion 131 of the first magnet 130 and the second end portion 141 of the second magnet 140. The positioning member 160 contacts against the first end portion 131 of the first magnet 130 and the second end portion 141 of the second magnet 140 to make the first magnet 130 and the second magnet 140 fixedly secured within the accommodating slot 111 of the case 110. Preferably, the positioning member 160 possesses elasticity, when the positioning member 160 contacts the first magnet 130 and the second magnet 140, the positioning member 160 will be deformed thereafter. Eventually, the first magnet 130 and the second magnet 140 are secured within the accommodating slot 111 of the case 110 via restoring force.

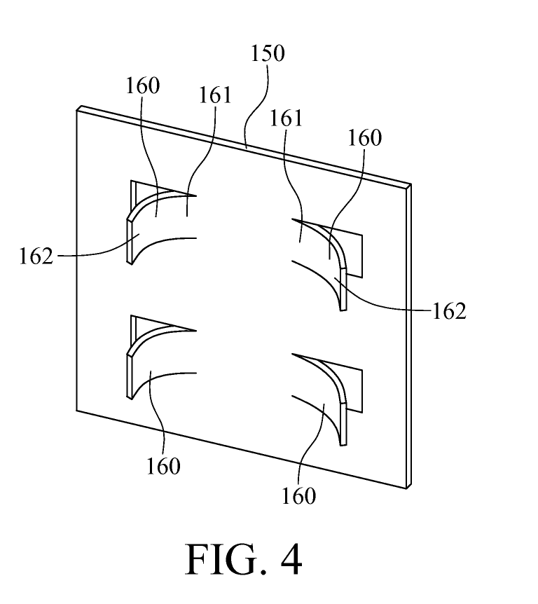

With reference to FIGS. 3 and 4, in this embodiment, the positioning member 160 and the at least one magnetic conductive plate 150 are integrally formed as one piece via a metal plate by means of punching process. The positioning member 160 comprises a connection portion 161 and a contact portion 162, wherein the connection portion 161 connects to the at least one magnetic conductive plate 150, the contact portion 162 protrudes from a surface of the at least one magnetic conductive plate 150, and the contact portion 162 contacts against the first end portion 131 of the first magnet 130 and the second end portion 141 of the second magnet 140. In this embodiment, the first end portion 131 of the first magnet 130 comprises a first exposure surface 131a, the second end portion 141 of the second magnet 140 comprises a second exposure surface 141a, the contact portion 162 is located between the first exposure surface 131a and the second exposure surface 141a, and the contact portion 162 contacts against the first exposure surface 131a of the first end portion 131 and the second exposure surface 141a of the second end portion 141.

In this invention, through the contact between the case 110 and the at least one magnet conductive plate 150 disposed within the spacing slot A, the reluctance of the motor structure 100 is well reduced to prevent the magnetic flux leakage from happening so that the air-gap flux density is increased therefore raising rotation performance.

While this invention has been particularly illustrated and described in detail with respect to the preferred embodiments thereof, it will be clearly understood by those skilled in the art that it is not limited to the specific features, descriptions, various modifications and changes in form and details may be made without departing from the spirit and scope of this invention.

What is claimed is:

1. A motor structure includes:
a case having an accommodating slot;
a rotor disposed within the accommodating slot;
a first magnet disposed between the case and the rotor, the first magnet comprises at least one first end portion, wherein the at least one first end portion and the case are spaced apart to define a first separation space;
a second magnet disposed between the case and the rotor, the second magnet comprises at least one second end portion, wherein the at least one second end portion and the case are spaced apart to define a second separation space, and a spacing slot is composed of the first separation space and the second separation space; and
at least one magnetic conductive plate disposed within the spacing slot and contacting the case.

2. The motor structure in accordance with claim 1 further includes at least one positioning member disposed between the at least one first end portion of the first magnet and the at least one second end portion of the second magnet.

3. The motor structure in accordance with claim 2, wherein the at least one positioning member and the at least one magnetic conductive plate are integrally formed as one piece.

4. The motor structure in accordance with claim 2, wherein the at least one positioning member comprises a connection portion and a contact portion, the connection portion connects to the at least one magnetic conductive plate, and the contact portion protrudes from a surface of the at least one magnetic conductive plate.

5. The motor structure in accordance with claim 3, wherein the at least one positioning member comprises a connection portion and a contact portion, the connection portion connects to the at least one magnetic conductive plate, and the contact portion protrudes from a surface of the at least one magnetic conductive plate.

6. The motor structure in accordance with claim 4, wherein the at least one first end portion of the first magnet comprises a first exposure surface, the contact portion of the positioning member is in contact with the first exposure surface of the at least one first end portion.

7. The motor structure in accordance with claim 5, wherein the at least one first end portion of the first magnet comprises a first exposure surface, the contact portion of the positioning member is in contact with the first exposure surface of the at least one first end portion.

8. The motor structure in accordance with claim 6, wherein the at least one second end portion of the second magnet comprises a second exposure surface, the contact portion of the at least one positioning member is in contact with the second exposure surface of the at least one second end portion.

9. The motor structure in accordance with claim 7, wherein the at least one second end portion of the second magnet comprises a second exposure surface, the contact portion of the at least one positioning member is in contact with the second exposure surface of the at least one second end portion.
